(19) United States
(12) Patent Application Publication
(10) Pub. No.: US 2025/0335858 A1
(43) Pub. Date: Oct. 30, 2025

(54) AI-ENHANCED INTELLIGENT WORKFLOW FOR IMPROVED PERSONAL PERFORMANCE

(71) Applicant: INTERNATIONAL BUSINESS MACHINES CORPORATION, Armonk, NY (US)

(72) Inventors: Lucia Larise Stavarache, Columbus, OH (US); Michael Jack Martine, Chapel Hill, NC (US); Sarah Diane Green, Chandler, AZ (US); Mark J. Ludlow, Fairfield, CT (US); Ira L. Allen, Dallas, TX (US); Stan Kevin Daley, Espanola, NM (US)

(21) Appl. No.: 18/644,698

(22) Filed: Apr. 24, 2024

(51) Int. Cl. G06Q 10/0639

(52) U.S. Cl. CPC G06Q 10/06393

(57) ABSTRACT

A computer-implemented method for determining, using a first large language model, a contextualized score based on contextualized metadata describing a user and at least one additional individual. The method may further include determining, using a second large language model, a personalized score by comparing personal parameters describing the user against historical parameters. Based on an aggregation of the contextualized score and the personalized score, the method may determine an individual benchmark. The method may further include determining an industry benchmark based on historical industry benchmarks. The method may further include generating an objective roadmap for the user based on the individual benchmark and the industry benchmark, where the roadmap includes first actions for improvement that are generated by measuring a first distance between a first status, the individual benchmark, and the industry benchmark.

### BACKGROUND

Aspects of the present invention relate generally to intelligent workflows and, more particularly, to methods, computer program products, and systems for improving personal performance in a systematic way that can be applied and molded according to user-specific strengths and/or weaknesses.

Career performance improvement refers to the ongoing process of enhancing one's skills, knowledge, abilities, and behaviors to excel in their professional role and achieve their career goals. It involves various strategies, actions, and initiatives aimed at increasing productivity, effectiveness, and overall success in the workplace. Career performance improvement can encompass a wide range of activities, including skill development, goal setting, learning, time management, etc.

Many organizations have performance review systems in place to set performance expectations, provide regular feedback, and evaluate employee performance. These systems often involve goal setting, performance reviews, and development planning to support career growth and improvement. In cases where an employee's performance is below expectations, organizations may implement performance improvement plans. These plans, generally developed by a manager or by a human resources specialist, outline specific goals, timelines, and actions for the employee to address performance issues and improve their performance.

### SUMMARY

In a first aspect of the invention, there is a computer-implemented method, including: determining, by a processor set using a first large language model, a contextualized score based on contextualized metadata describing a user and at least one additional individual; determining, by the processor set using a second large language model, a personalized score by comparing personal parameters describing the user against historical parameters; determining, by the processor set, an individual benchmark based on an aggregation of the contextualized score and the personalized score; determining, by the processor set, an industry benchmark based on historical industry benchmarks; and generating, by the processor set, an objective roadmap for the user based on the individual benchmark and the industry benchmark, the roadmap including first actions for improvement that are generated by measuring a first distance between a first tracked status, the individual benchmark, and the industry benchmark.

In another aspect of the invention, there is a computer program product including one or more computer readable storage media having program instructions collectively stored on the one or more computer readable storage media. The program instructions are executable to: determine, using a first large language model, a contextualized score based on contextualized metadata describing a user and at least one additional individual; determine, using a second large language model, a personalized score by comparing personal parameters describing the user against historical parameters; determine an individual benchmark based on an aggregation of the contextualized score and the personalized score; determine an industry benchmark based on historical industry benchmarks; and generate an objective roadmap for the user based on the individual benchmark and the industry benchmark, the roadmap including first actions for improvement that are generated by measuring a first distance between a first tracked status, the individual benchmark, and the industry benchmark.

In another aspect of the invention, there is a system including a processor set, one or more computer readable storage media, and program instructions collectively stored on the one or more computer readable storage media. The program instructions are executable to: determine, using a first large language model, a contextualized score based on contextualized metadata describing a user and at least one additional individual; determine, using a second large language model, a personalized score by comparing personal parameters describing the user against historical parameters; determine an individual benchmark based on an aggregation of the contextualized score and the personalized score; determine an industry benchmark based on historical industry benchmarks; and generate an objective roadmap for the user based on the individual benchmark and the industry benchmark, the roadmap including first actions for improvement that are generated by measuring a first distance between a first tracked status, the individual benchmark, and the industry benchmark.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIGS. 3A and 3B show flowcharts of an exemplary method in accordance with aspects of the present invention.

FIG. 4 shows a flowchart of an exemplary method in accordance with aspects of the present invention.

FIG. 5 shows a tabular chart of exemplary data and algorithms in accordance with aspects of the present invention.

### DETAILED DESCRIPTION

Aspects of the present invention relate generally to intelligent workflows and, more particularly, to methods, computer program products, and systems for improving personal performance in a systematic way that can be applied and molded according to user-specific strengths and/or weaknesses. In other words, the methods, computer program products, and systems integrate individualized user performance, historical benchmarks, and contextual data to determine objective progress and to identify genuine and non-conventional insights into user achievements or shortcomings patterns. The methods, computer program products, and systems may further use the amalgamation of contextual, individualized, and historical benchmarks into a comprehensive user performance plan to improve the user's performance.

According to an aspect of the invention, there is a computer-implemented method and system for an intelligent workflow for improved personal performance that includes determining, using a first recurrent neural network (RNN), a contextualized score based on contextualized metadata collected about an individual and other employees in similar contexts. The method and system may further include determining, using a second RNN, a personalized score based on personal metadata/parameters including interactions, communications, habits, and action tracking of the individual compared against historical parameters, and determining an individual benchmark based on the contextualized score and the personalized score. In embodiments, the system and method may also determine an industry benchmark based on historical industry benchmarks from external data and generate a personalized trackable objective roadmap for the individual based on the individual benchmark and the industry benchmark. The method and system may further include generating, using a machine learning model, personalized analytics and actions for improvement based on measuring distance between individual tracked status and the individual benchmark and the industry benchmark.

Implementations of the invention are necessarily rooted in computer technology. For example, the steps of determining, using a first large language model, a contextualized score based on contextualized metadata describing a user and at least one additional individual and determining, using a second large language model, a personalized score by comparing personal parameters describing the user against historical parameters, are computer-based and cannot be performed in the human mind (or with pen and paper) due to the complexity and massive amounts of calculations involved. For example, artificial intelligence algorithms, such as large language models (LLM) including RNNs, may have millions or even billions of weights that represent connections between nodes in different layers of the model. The values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Implementations of the invention improve the technological field of intelligent workflows for improving personal performance. As explained above, the methods, computer program products, and systems integrate individualized user performance, historical benchmarks, and contextual data to determine objective progress and to identify genuine and non-conventional insights into user achievements or shortcomings patterns. In other words, the methods, computer program products, and systems may further use the amalgamation of contextual, individualized, and historical benchmarks into a comprehensive user performance plan to improve the user's performance.

Existing technologies fall short and do not provide individualized performance plans and do not provide plans that are molded according to user-specific strengths and/or weaknesses. Simply stated, the existing art focuses on a narrow individual profile (e.g., the sales professional or fitness recommendation based on user physical condition, student application success prediction, HR compensation benchmarks), and sets a predefined context of success, with clear differences. Existing techniques are not dynamic and apply one-size-fits-all methods. However, humans do not often fit the one-size-fits-all mold.

Furthermore, existing art is passive, acting as trackers and only tailored to industry benchmarks, e.g., it recommends a specific approach based on a variety of personality tests which are never 100% accurate, or generic benchmarking the person against a body mass index (BMI) with no consideration of genetics and body type. The passivity of the existing art, and its reliability, based generally on aggregated benchmarks make them insufficient and unreliable.

Performance improvement is different for everyone, so the difficulty arises in effectively utilizing technology in a repeatable and methodized manner to help individual performance improvement grow. Embodiments and aspects of the invention approach the performance problem differently using a plurality of individual and industry benchmark dimensions to set a personalized, yet trackable, objective roadmap within a repeatable method. The dimensions in scope are contextualized metadata, personalized metadata, and industry historical benchmarks. Historical benchmarks refer to existing data and benchmarks that may be used to measure and assess and individual's/user's performance.

Embodiments and aspects of the invention provide an intelligent workflow (IW) method powered by deep artificial intelligence (AI) insights that can combine and rationalize against the multiple dimensions and ensure that the inputs and outputs of each IW step are trackable and repeatable. The insights gained are further re-used to assess risk versus individual objectives. Embodiments and aspects of the invention further provide an ability to track the inputs and outputs of each IW step and adjust the IW as the user's performance changes. Furthermore, users can modify their profiles, ensuring these alterations are mirroring their objectives within the performance roadmap, thereby granting users the ability to customize their trajectory for continuous improvement. Thus, improving the technological field of intelligent workflows for improving personal performance.

It should be understood that, to the extent implementations of the invention collect, store, or employ personal information (e.g., education, training, self-evaluations, performance testing, health history, etc.) provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the intelligent workflow server code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

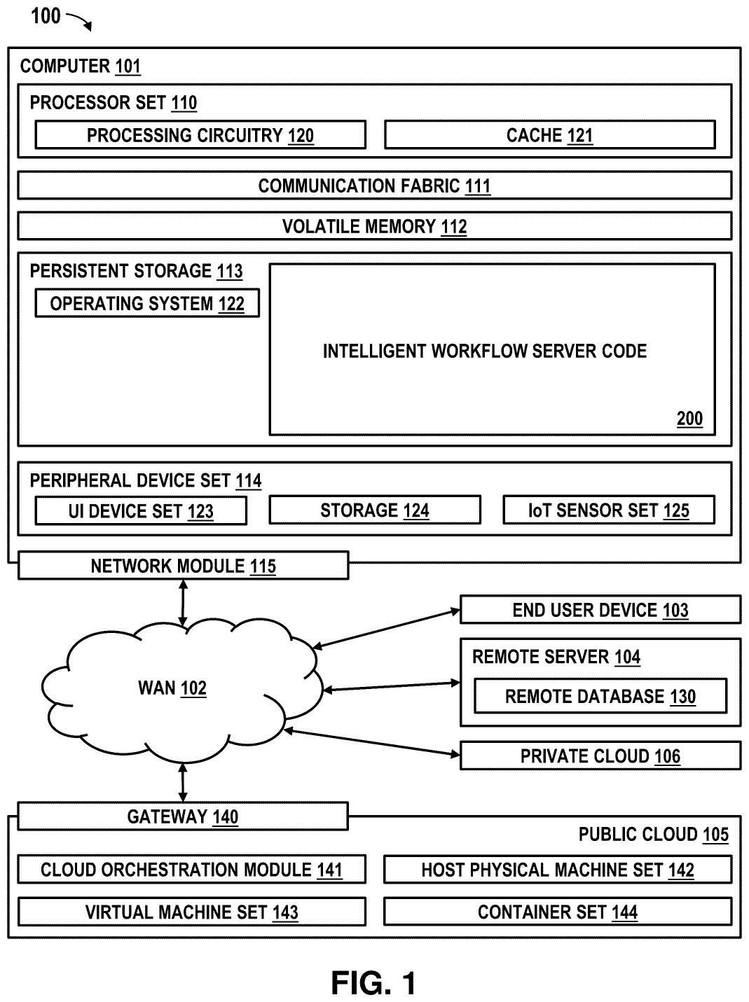

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

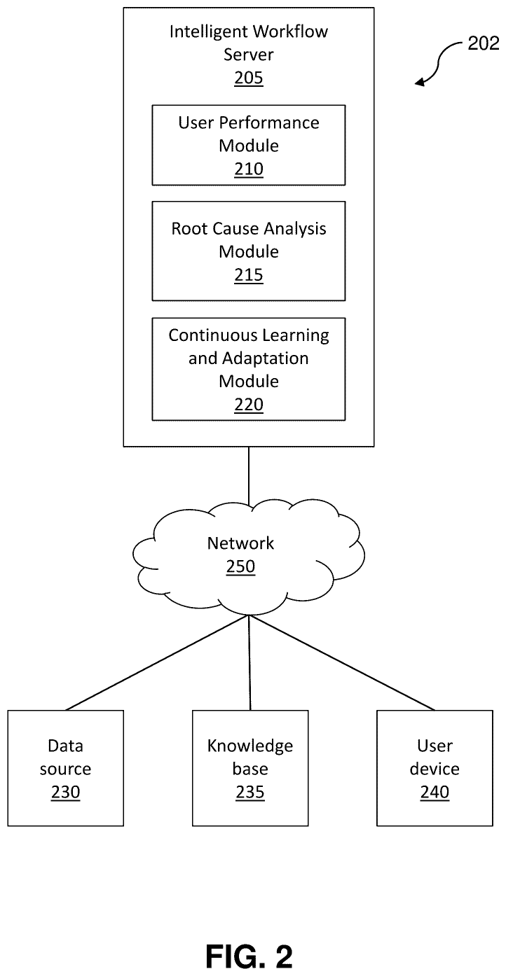

FIG. 2 shows a block diagram of exemplary environment 202 in accordance with aspects of the invention. In embodiments, environment 202 includes intelligent workflow server 205, data source 230, knowledge base 235, user device 240, and network 250.

Intelligent workflow server 205 may comprise one or more instances of computer 101 of FIG. 1. In another example, intelligent workflow server 205 may comprise one or more virtual machines or containers running on one or more instances of computer 101 of FIG. 1. In embodiments, intelligent workflow server 205 communicates with data source 230, knowledge base 235, and user device 240 via network 250, which may comprise WAN 102 of FIG. 1. In embodiments, data source 230 comprises one or more data sources each comprising an instance of remote database 130 and/or remote server 104 of FIG. 1. In embodiments, knowledge base 235 also comprises one or more data sources each comprising an instance of remote database 130 and/or remote server 104 of FIG. 1. In embodiments, user device 240 comprises one or more instances of end user device 103 of FIG. 1. There may be plural different instances of user device 240 including, for example, user-accessible servers and/or personal computing devices. The different instances of user device 240 may be used by different users and evaluators, respectively.

In embodiments, intelligent workflow server 205 of FIG. 2 comprises user performance module 210, root cause analysis module 215, and continuous learning and adaptation module 220, each of which may comprise modules of intelligent workflow server code of block 200 of FIG. 1. Such modules may include routines, programs, objects, components, logic, data structures, and so on that perform a particular task (or tasks) or implement a particular data type (or types) that the intelligent workflow server code of block 200 uses to carry out the functions and/or methodologies of embodiments of the invention as described herein. These modules of intelligent workflow server code of block 200 are executable by computer 101 of FIG. 1 (e.g., processing circuitry 120 of FIG. 1) to perform the inventive methods as described herein. Intelligent workflow server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, user performance module 210 may be optionally configured to receive and/or access contextualized metadata (i.e. dimensions) about a user and/or at least one other individual in similar contexts. That is, the user performance module 210 may receive metadata describing a user and metadata describing at least one other individual, where the data describing the user and the at least one other individual describes the same (or similar) context.

As used herein, contextualized data (including metadata) refers to all information about the context where the user and/or other individuals are present, with a focus on elements that are measurable. For example, in embodiments contextual metadata may be job, role, and/or profile data including job role skill set (JRSS) coding associated with a job role, project profile data, social data, feedback data, and performance data. In embodiments, project profile data may include internal and external projects, project type, a description of whether it is a large, medium, or small project, a regional or global project, whether there are diverse types of projects, daily activities, daily/weekly/monthly schedules, and/or other data that describes a user's day-to-day efforts and tasks. In embodiments, social data may include a level of interest in a meeting, number of times speaking and/or commenting during a meeting, length of time speaking during a meeting, audience interest in a meeting, etc. In embodiments, feedback data may include feedback from peers, managers, and stakeholders, including 360-degree feedback (i.e., an assessment system or process in which employees receive confidential, anonymous evaluations from the people who work around them). In embodiments, performance data may include career goals, project reflections, lessons learned, and/or other data used to reflect on a past performance including percent of market reference (PMR) (i.e., a ratio used to measure how an employee's salary compares to the average market rate for their role). Furthermore, as used herein, context may be a workplace, sport, activity, career, an individual's role within a job or team, projects the individual is working on, or any other characterizations of the contextual data examples provided herein.

In embodiments, user performance module 210 is further configured to determine, using a first LLM built using a neural network framework such as an RNN, a contextualized score based on the contextualized metadata. That is, the first LLM/RNN uses the contextualized metadata about a user and/or at least one other individual in similar contexts to determine a contextualized score. In embodiments, the first LLM/RNN determines individual contextualized scores for each portion/parameter/dimension/aspect of contextualized data. In additional embodiments, the first LLM/RNN additionally (or alternatively) determines a total contextualized score for the aggregated (e.g., combined portions/parameters/dimensions/aspects) contextualized data. In embodiments, the first LMM uses a test-train repository where the contextualized metadata is embedded into vectors within the LMM and is compared with/against other individuals within the same contexts.

In embodiments, user performance module 210 may be further configured to determine, using a second LLM built using a neural network framework such as a second RNN, a personalized score by comparing personal parameters (i.e., dimensions) describing the user against historical parameters. In embodiments, the second LLM/RNN determines personalized scores for each personal parameter. In additional embodiments, the second LLM/RNN additionally (or alternatively) determines a total contextualized score for the aggregated (e.g., parameters) personalized data. In embodiments, the second LLM's input layer represents each personal parameter as separate input nodes and the input nodes are connected to one or more fully connected layers. In embodiments, one or more non-linear activation functions may be used to introduce non-linearity and to help the LLM learn complex relationships. In such embodiments, the activation functions may include a rectified linear unit (ReLU), a hyperbolic tangent (tanh), a sigmoid function, and/or any other non-linear activation function that may introduce non-linearity and to help the LLM learn complex relationships. In embodiments, the first and second LLMs/RNNs may employ the same large language learning model, but are trained to determine different scores (e.g., a contextualized score and a personal score, respectively).

In embodiments, personal parameters may include one or more of interaction data, communication data, skills data, habit data, and/or tracked data/status. Interaction data may include coaching, mentoring, learning, volunteering, participation in community activities, innovating, inventing, patenting, and the like, with each interaction data being quantified (e.g., how often, how many, feedback score, diversity, etc.). Communication data may include mail or email correspondences, social media interactions, classes taken or taught, training taken or taught, webinars attended or given, speaking engagements, and the like, with each communication data being quantified (e.g., how often, how many, feedback, etc.). Skills data may include qualitative and quantitative data describing a user's actual skills, relevance of the skills to a current task (e.g., project, job, career, team), relevance of the skills to a future task (e.g., project, job, career, team). Habit data may include vacation (e.g., duration and times), working time (e.g., regional and/or global), time zone, business travel, health habits such as being a part of professional well-being communities, breaks between meetings (e.g., going for a walk, consuming a refreshment, or other activities to unwind and/or reset). Tracked data/status may include any data (e.g., status data) that the user enters as related to trackable tasks (e.g., goals, steps, roadmap stages, etc.) and/or a level of completion of such tasks. Using the personal parameters, the recurrent neural network may have a 360-degree overview of the user through the personal parameters. In embodiments, personal parameters may be provided by the user. In other embodiments, personal parameters may be additionally (or alternatively) provided by individuals that have a relationship with the user (e.g., friends, family, colleagues, managers, etc.). In embodiments, the personal parameters may be weighted. In such embodiments, weighting means that personal parameters that are more correlated to the user's performance for a specific job/task, may be given a higher weight such that those features have a greater influence on the personalized score. Also, in such embodiments, personal parameters that are less correlated to the user's performance for a specific job/task, may be given a lower weight such that those features have a lesser influence on the personalized score.

Historical parameters refer to existing data and benchmarks used to measure and assess performance of individuals within the same context as the personal parameters. For example, if a personal parameter measures a user's ability to communicate in a large group setting, the historical parameters provide a benchmark for other individuals and their ability to communicate in large group settings. In another example, if the personal parameter describes a user's number of vacation days taken per year, the corresponding historical parameter provides a benchmark for other similar individuals and their number of vacation days taken per year. In embodiments, historical parameters may include performance history data models, match/compare performance, industry-accepted benchmarks, success models, etc. In embodiments, the historical parameters may be obtained from private, public, and/or entity information sources. Examples of private, public, and/or entity information sources include personal information, organization data and applications, business to business (B2B) applications, business to consumer (B2C) applications, subject matter experts, strategists, futurists, National Oceanic and Atmospheric Administration (NOAA), government-provided data, statistics organizations, news agencies, subscription data, security services, service management, blockchain networks, and/or any other private or public information source that may be useful in establishing a benchmark for a user's personal performance.

In accordance with aspects of the invention, root cause analysis module 215 is configured to determine an individual benchmark based on an aggregation of the contextualized score and the personalized score. That is, root cause analysis module 215 may be configured to break down the contextualized score and the personalized score into each dimension and may optionally offer an in-depth report of the user's performance. In embodiments, if the user opts in, root cause analysis module 215 may also compare the user's contextualized score, personalized score and/or profile against that of other individuals. In embodiments, the other individuals with whom the scores are compared may be individuals in the same context of the user and/or individuals that the user aspires to be and/or be more like. In embodiments, the aggregation of the contextualized score and the personalized score are normalized to better understand the insights provided by the aggregated scores.

In embodiments, root cause analysis module 215 may be further configured to determine an industry benchmark based on historical industry benchmarks. In other words, root cause analysis module 215 may be configured to determine an industry benchmark that is related to the context of the user to compare the user's performance against that of historical benchmark data.

In embodiments, root cause analysis module 215 may be further configured to generate a trackable objective roadmap for the user based on the individual benchmark and the industry benchmark. As used herein, a trackable objective roadmap comprises at least one user-determined and/or machine-learning prescribed action that the user may perform/complete to achieve a desired improvement. In embodiments, the roadmap may include a plurality of actions to be performed or completed in a sequential order to achieve the desired improvement. For example, a roadmap may comprise sequential steps that build on one another, such as perform task 1, then complete action 2, and finish action 3. In other embodiments, the roadmap may comprise groups of tasks that are performed in sequential order. For example, a roadmap may comprise perform all tasks in group 1, then complete all actions in group 2, where each of groups 1 and 2 comprise more than one task/action. In embodiments, the roadmap may include an additional step(s) to dynamically adjust and reevaluate the user-determined and/or prescribed actions. Thus, in this manner, root cause analysis module 215 may use the individual benchmark and the industry benchmark to determine where a user needs improvement, and using that data, generates a trackable objective roadmap for the user to improve and decrease the gap between their performance and the individual and industry benchmarks. Accordingly, root cause analysis module 215 conducts an exhaustive root cause analysis of a user's progression against set objectives, either pre-determined or advised by artificial intelligence. This implementation is adept at identifying genuine and non-conventional insights into user achievements or shortcomings patterns. Furthermore, this implementation moves beyond rudimentary or domain-specific performance measurements, instead it represents the amalgamation of contextual data, individualized data, and historical benchmarks into a comprehensive roadmap (i.e., user performance plan).

In embodiments, root cause analysis module 215 may be further configured to map each of the goals and scores into a star map and determine the gaps and progress, with a clear pathway on how to return to root cause analysis. In such examples, the root cause analysis module 215 may perform back propagation to provide an explanation for why the user has earned the personalized scores and the contextualized scores.

In accordance with aspects of the invention, continuous learning and adaptation module 220 is configured to generate first actions for improvement by measuring a first distance between individual tracked status (e.g., tracked data), the individual benchmark, and the industry benchmark. In other words, continuous learning and adaptation module 220 generates goals for the user to improve their performance in specific areas of weakness that are identified by measuring the distance between the individual tracked status, the individual benchmark, and the industry benchmark. In embodiments a machine learning model may be employed to generate the first actions for improvement, the individual tracked status, individual benchmark, and the industry benchmark may be used as inputs to help train the machine learning model to generate the first actions. In such embodiments, a linear regression algorithm, logistic regression algorithm, decision tree algorithm, and/or Naïve Bayes algorithm may be used to generate the second actions.

In embodiments, continuous learning and adaptation module 220 may be further configured to track the user's progress (i.e., tracked data/status) as the user performs/updates the actions for improvement. In embodiments, the trackable data is received from the user and is federated as the user enters the data. For example, an application, a tracker, or other space may be provided where a user may enter and update performance progress/monitoring.

In embodiments, continuous learning and adaptation module 220 may be optionally configured to generate second actions for improvement by measuring a second distance between individual tracked data/status, a second individual benchmark, and the industry benchmark. In embodiments, the second actions are generated to update the next steps for the user to continue to improve performance. In embodiments a machine learning model may be employed to generate second actions for improvement, the individual tracked status, a second individual benchmark, and the industry benchmark may be used as inputs to help train the machine learning model to generate the second actions. In such embodiments, a linear regression algorithm, logistic regression algorithm, decision tree algorithm, and/or Naïve Bayes algorithm may be used to generate the second actions.

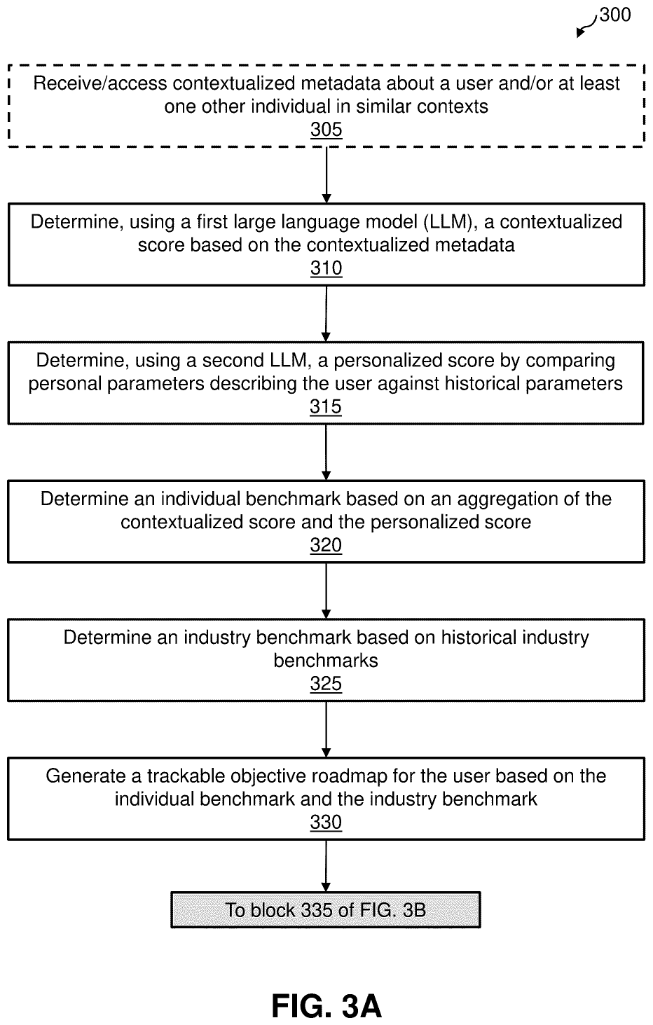

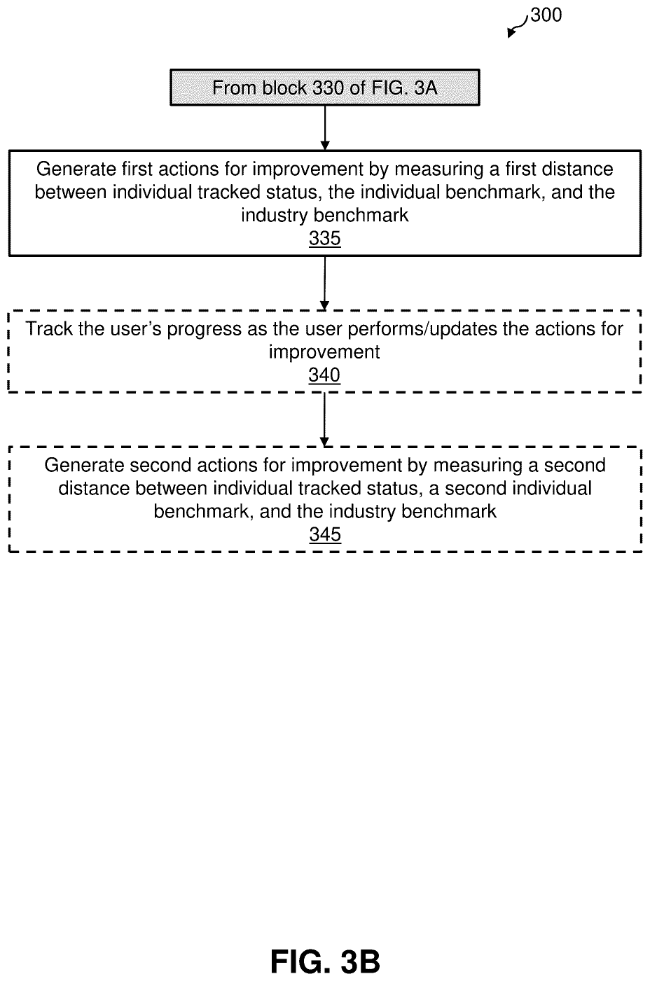

FIGS. 3A and 3B show flowcharts of exemplary method 300 in accordance with aspects of the present invention. Steps of the method may be carried out in the environment of FIG. 2 and are described with reference to elements depicted in FIG. 2.

At block 305 of FIG. 3A, user performance module 210 may be optionally configured to receive and/or access contextualized metadata (i.e. dimensions) about a user and/or at least one other individual in the same (or similar) context(s). That is, the user performance module 210 may receive metadata describing a user and metadata describing at least one other individual, where the data describing the user and the at least one other individual describes the same (or similar) context. As provided above, contextualized data (including metadata) refers to all information about the context where the user and/or other individuals are present, with a focus on elements that are measurable.

In embodiments, the contextualized metadata may be received from a data source (such as data source 230 of FIG. 2) or a user device (such as user device 240 of FIG. 2). In other embodiments, user performance module 210 may access (e.g., obtain, download, or the like) the metadata at/from a data source (such as data source 230 of FIG. 2) or at/from a user device (such as user device 240 of FIG. 2).

At block 310, user performance module 210 of FIG. 2 is configured to determine, using a first LLM built using a neural network framework such as a first RNN, a contextualized score based on the contextualized metadata. That is, the first LLM/RNN uses the contextualized metadata about a user and/or at least one other individual in similar contexts to determine a contextualized score. In embodiments, the first LLM/RNN determines individual contextualized scores for each portion/parameter/dimension/aspect of contextualized data. In additional embodiments, the first LLM/RNN additionally (or alternatively) determines a total contextualized score for the aggregated (e.g., combined portions, parameters, dimensions, and/or aspects) contextualized data.

In embodiments, the first LLM/RNN uses a test-train repository where the contextualized metadata is embedded into vectors within the LLM/RNN and is compared with/against other individuals within the same contexts. A higher contextualized score indicates that the user is performing above expectations (i.e., above the level of its peers), a lower contextualized score indicates that the user is performing below expectations (i.e., below the level of its peers). In embodiments, a score that falls between the low and high score thresholds indicates that the user is performing at expectations (i.e., at the level of its peers). As used herein, peers may include coworkers, individuals having a same/similar position in another company or firm, teammates, opponents, individuals within a same/similar demographic cohort, individuals having a same or similar physical condition, etc. Returning to the contextualize scoring, in an exemplary embodiment in a career/workplace setting, contextualized scores may be assessed using three categories. That is, in an embodiment where the contextualized scores are given as a number between zero and 100 (0-100), scores that fall below 30 represent a low contextualized score, scores that rise above 70 represent a high contextualized score, and scores that fall between the low and high thresholds represent an average contextualized score. In an exemplary implementation, the contextual metadata may measure a user's connection to their professional environment and their career path. In such embodiments, a contextualized score that is less than 30 indicates that the user is not connected to their professional environment, a contextualized score that is more than 70 indicates that the user is on a career path promotion, and a contextualized score between 30-70 indicates that the user is connected to their environment and is stable in their career progression. In embodiments, more than three categories may be used. For example, in some implementations, the contextualized scores may be categorized according to two categories while in other implementations the contextualized scores may be categorized according four, five, or more categories.

At block 315, user performance module 210 of FIG. 2 is configured to determine, using a second LLM built using a neural network framework such as a second RNN, a personalized score by comparing personal parameters (i.e., dimensions) describing the user against historical parameters. In embodiments, the second LLM/RNN determines personalized scores for each personal parameter. In additional embodiments, the second LLM/RNN additionally (or alternatively) determines a total contextualized score for the aggregated (e.g., parameters) personalized data.

A provided above, personal parameters may include one or more interaction data, communication data, skills data, habit data, and/or tracked data. Historical parameters, as explained above, refer to existing data and benchmarks used to measure and assess performance of individuals within the same context as the personal parameters. In embodiments, the second LLM/RNN's input layer represents each personal parameter as separate input nodes and the input nodes are connected to one or more fully connected layers. In embodiments, one or more non-linear activation functions may be used to introduce non-linearity and to help the LLM learn complex relationships. In such embodiments, the activation functions may include an ReLU, a tanh, a sigmoid function, and/or any other non-linear activation function that may introduce non-linearity and to help the LLM learn complex relationships. In embodiments, the output layer of the second LLM/RNN comprises a single neuron value within a range of 0-100. In embodiments, the second LLM/RNN employs mean square error (MSE) (i.e., an estimator that measures the average of the squares of the errors) or mean absolute error (MAE) (i.e., a measure of errors between paired observations expressing the same phenomenon), as loss functions. Furthermore, in embodiments, existing historical benchmarks from such as client internal, market insights, human resource data, and/or external data may be used to train a labeled dataset. Finally, in embodiments, the second LLM/RNN may use a stochastic gradient descent (SGD) or an Adam optimization algorithm to optimize the LLM/RNN. In embodiments, the first LLM/RNN and/or second LLM/RNN may be replaced or supplemented with another large language model, built using a neural network framework, that can perform the data analysis provided above.

At block 320, root cause analysis module 215 is configured to determine an individual benchmark based on an aggregation of the contextualized score and the personalized score. That is, root cause analysis module 215 may be configured to break down the contextualized score and the personalized score into each dimension and may optionally offer an in-depth report of the user's performance. As explained above, in embodiments, if the user opts in, root cause analysis module 215 may also compare the user's contextualized score, personalized score and/or profile against that of other individuals. In embodiments, the other individuals with whom the scores are compared may be individuals in the same context of the user and/or individuals that the user aspires to be and/or be more like. In embodiments, the aggregation of the contextualized score and the personalized score are normalized to better understand the insights provided by the aggregated scores.

At block 325, root cause analysis module 215 is configured to determine an industry benchmark based on historical industry benchmarks. As explained above, a historical benchmark refers to existing data and benchmarks that might be used to measure and assess a user's performance. Therefore, root cause analysis module 215 may be configured to determine an industry benchmark that is related to the context of the user to compare the user's performance against that of historical benchmark data.

At block 330, root cause analysis module 215 is configured to generate a trackable objective roadmap for the user based on the individual benchmark and the industry benchmark. As provided above, root cause analysis module 215 conducts an exhaustive root cause analysis of a user's progression against set objectives, either pre-determined or advised by artificial intelligence. This implementation is adept at identifying genuine and non-conventional insights into user achievements or shortcomings patterns. Furthermore, this implementation moves beyond rudimentary or domain-specific performance measurements, instead it represents the amalgamation of contextual data, individualized data, and historical benchmarks into a comprehensive user performance plan.

In an exemplary case where a user seeks to improve their communication skills and where it has been determined that the user's skills are behind that of their peers, root cause analysis module 215 may be configured to correlate the personalized scores and the contextualized scores to generate a communication-related goal with respect to the user's interactions, communications, and habits. For example, root cause analysis module 215 may use similarity techniques for text to evaluate how much of the user actions and communication is connected to the goal, and suggest ways to improve interactions, communications, and habits to improve communication.

In embodiments, root cause analysis module 215 may further map each of the goals and scores into a star map and determine the gaps and progress, with a clear pathway on how to return to root cause analysis. In other words, root cause analysis module 215 can explain why the user is in their current state with respect to specific parameters. This additional information may be helpful for a user to better understand actions for improvement and goals for improving performance.

At block 335 of FIG. 3B, continuous learning and adaptation module 220 is configured to generate first actions for improvement by measuring a first distance between individual tracked status, the individual benchmark, and the industry benchmark. In other words, as provided above, continuous learning and adaptation module 220 generates goals for the user to improve their performance in specific areas of weakness that are identified by measuring the distance between the individual tracked status, the individual benchmark, and the industry benchmark. In embodiments, continuous learning and adaptation module 220 may employ at least one machine learning algorithm/model to generate the first actions. As noted above, in such embodiments, a linear regression algorithm, logistic regression algorithm, decision tree algorithm, and/or Naïve Bayes algorithm may be used to generate the first actions. In embodiments the first actions may be part of the trackable objective roadmap, meaning, the roadmap may include the first actions.

At block 340, continuous learning and adaptation module 220 is configured to track the user's progress as the user performs/updates the actions for improvement. In embodiments, the trackable data is received from the user and is federated as the user enters the data. For example, an application, a tracker, or other space may be provided where a user may enter and update performance progress/monitoring. In such embodiments, continuous learning and adaptation module 220 may aggregate the total progress the user has made (or is making) with respect to each step/dimension/parameter and update the personalized score and/or the contextualized score.

In embodiments, the system sends a notification, alert, reminder, and/or the like to the user to encourage the user to enter the applicable data. In embodiments, the trackable data is automatically received from a user device, but only after the user has opted in to having their data automatically shared with continuous learning and adaptation module 220. For example, when the user has opted in to having their data automatically shared with continuous learning and adaptation module 220, the user's smartphone, calendar, meeting platforms, etc., may automatically update a user's performance data based on the user's interaction with those devices, software, applications, etc.

At block 345, continuous learning and adaptation module 220 may be optionally configured to generate second actions for improvement by measuring a second distance between individual tracked status, a second individual benchmark, and the industry benchmark. In embodiments, the second actions are generated to update the next steps for the user to continue to improve performance. In this manner, and according to aspects of the invention, the actions and individual benchmarks may be updated to better reflect the user's status/performance and to better tailor the updated (i.e., second, third, etc.) actions for improvement to the user's specific needs. By updating the actions for improvement and by updating the individual benchmarks, the methods and systems described herein provide a dynamic and highly individualized plan to improve the user's performance. In embodiments, continuous learning and adaptation module 220 may employ at least one machine learning algorithm/model to generate the second (and any subsequent) actions. As noted above, in such embodiments, a linear regression algorithm, logistic regression algorithm, decision tree algorithm, and/or Naïve Bayes algorithm may be used to generate the second (and/or any subsequent) actions. In embodiments the second actions may be part of the trackable objective roadmap, meaning, the roadmap may include the second actions.

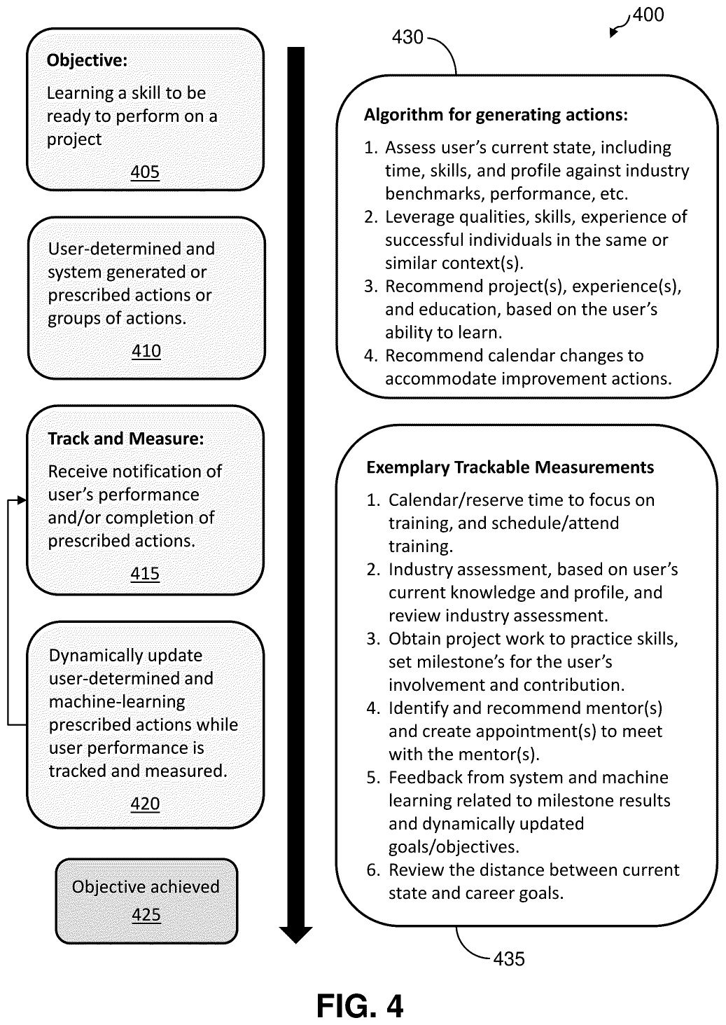

FIG. 4 shows a flowchart of exemplary method 400 in accordance with aspects of the present invention. Steps of the method may be carried out in the environment of FIG. 2 and are described with reference to elements depicted in FIGS. 2 and 3A-B.

In an exemplary use case depicted in FIG. 4, and using the systems, methods, and blocks described above, a professional user strives to balance personal improvement and productivity with well-being. The user's personal goals and current performance data are incorporated into an intelligent workflow (e.g., method 400) through a variety of means. For example, the system (such as portions of intelligent workflow server 205 of FIG. 2) analyzes the user's inputs against contextual metadata, personal current performance, and industry benchmarks, creating a list of roadmap goals/actions ranked by risk aligned with the user's key strengths. In embodiments the user's input may be analyzed using natural language processing (NLP) and k-means to cluster the inputs and/or actions to create the list of roadmap goals/actions.

For example, at block 405, the system may request, receive, or otherwise obtain an objective from the user. As shown in block 405, a received objective may include learning a new skill to be ready to perform on a project. In other embodiments, a user may wish to improve its communication skills, its writing skills, and/or the user may wish to improve other skills such as time management, leadership, organization, public speaking, networking, etc. In embodiments, the user may set objectives that include improved health (e.g., weight loss, improved sleep habits, etc.), improved athletic skill/ability (e.g., improved tennis, golf, basketball, skills, etc.), a job-specific skill (e.g., task management, task planning, etc.), and/or any other improvement in personal performance.

At block 410, the user can add goals that may be assessed and ranked. Additionally, or alternatively, the system may generate or prescribe actions or group of actions for the user to follow (e.g., a roadmap). In embodiments, the system may generate actions using the algorithm of block 430. Specifically, the system may assess the user's current state with respect to their desired objective, including the user's time, skills, and profile against industry benchmarks, performance, etc. The system may further leverage qualities, skills, experience of successful individuals in the same or similar context(s). With the foregoing information, the system may recommend project(s), experience(s), and education, based on the user's ability to learn. The system may also recommend, or in some embodiments automatically make, calendar changes to accommodate the generated/prescribed improvement actions.

In embodiments, the roadmap takes external input but is only available to the user, the user can select which of the goals or roadmap (if any) it wants to share with others. If the user would like to share any goals or roadmap with others, the user must first opt-in to sharing that data.

Then, an objective roadmap is generated for the user with milestones, potential risks, and mitigation strategies to ensure a well-rounded growth trajectory (in accordance with blocks 310-335 of FIGS. 3A-B). For example, the generated roadmap (e.g., trackable measurements) may include, as illustrated in block 435, actions such as calendaring time to focus on, and attend, training, review an industry assessment created based on user's current knowledge and profile compared with others in the industry; obtain project work to practice skills and set milestones for the user's involvement and contribution; identify and recommend mentor(s), then create appointment(s) to meet the mentor(s); and review system and machine learning feedback related to milestone results and the dynamically updated goals/objectives. In embodiments, the roadmap may include other steps or groups of steps to help the user obtain their objective(s).

At block 415, the system may track and measure the user's progress by receiving notification of user's performance and/or completion of prescribed actions. This may be performed using, for example, continuous learning and adaptation module 220 of FIG. 2 as described with respect to block 340 of FIG. 3B.

At block 420, the system may dynamically update the user-determined and system generated actions while, or alternatively after, the user performance is tracked and measured. This may be performed using, for example, continuous learning and adaptation module 220 of FIG. 2 as described with respect to block 345 of FIG. 3B. In embodiments, after the user has completed the first prescribed actions, the system may generate additional actions to help the user continue to progress. For example, if the user is working on public speaking, after the user has attended training, worked with mentors, etc., new tasks may be generated to conduct meetings, prepare 30-second speeches, etc., based on the user's performance and completion of the first-prescribed actions. In this manner, the generated roadmap is dynamic and may be adjusted/updated as the user progresses toward the ultimate objective. At block 435 the objective is achieved when the roadmap is complete.

As noted above, while FIG. 4 illustrates an embodiment for a professional user striving to balance personal improvement and productivity with well-being, additional embodiments may provide a roadmap for achieving improved health, improved athletic skill/ability, job-specific skills, and/or any other improvement in personal performance.

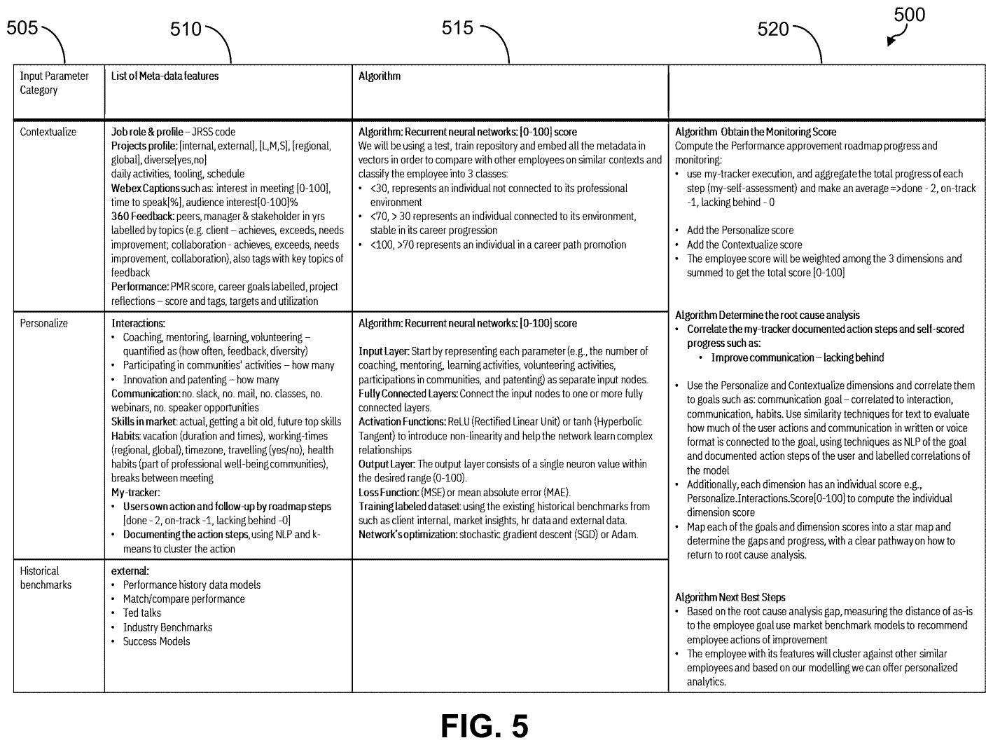

FIG. 5 shows tabular chart 500 of exemplary data and algorithms in accordance with aspects of the present invention. Steps of the method may be carried out in the environment of FIG. 2 and are described with reference to elements depicted in FIGS. 2 and 3A-B.

Input parameter category column 505 introduces the input categories for an exemplary embodiment in accordance with aspects of the present invention. As shown, in embodiments, there may be three categories: contextualize, personalize, and historical benchmarks.

List of metadata features column 510 provides non-exhaustive lists of the type of data that may be received, obtained, determined, and/or generated for each of the three categories of input parameter category column 505. As noted above, the contextualized metadata may be used by user performance module 210 of FIG. 2 determine contextualized score based on the contextualized metadata. In embodiments, the contextualized score may be determined in accordance with block 310 of FIG. 3A. In embodiments, the algorithms in algorithm column 515 of FIG. 5 may also be used to determine, at least in part, the contextualized score.

Similarly, as noted above, the personalized metadata may be used by user performance module 210 to determine a personalized score by comparing personal parameters (e.g., listed in the list of metadata features column 510) against historical parameters (e.g., also listed in the list of metadata features column 510). In embodiments, the personalized score may be determined in accordance with block 315 of FIG. 3A. In embodiments, the algorithms in algorithm column 515 of FIG. 5 may also be used to determine, at least in part, the personalized score.

Column 520 provides additional algorithms for obtaining a monitoring score, in accordance with block 320 of FIG. 3A. Column 520 further provides an algorithm for determining the root cause of a user's score in accordance with blocks 320-325 of FIG. 3A. Column 520 further provides an algorithm for determining the next best steps in accordance with block 330 of FIG. 3A and blocks 335-345 of FIG. 3B.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system may include one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a processor set using a first large language model, a contextualized score based on contextualized metadata describing a user and at least one additional individual;
determining, by the processor set using a second large language model, a personalized score by comparing personal parameters describing the user against historical parameters;
determining, by the processor set, an individual benchmark based on an aggregation of the contextualized score and the personalized score;
determining, by the processor set, an industry benchmark based on historical industry benchmarks; and
generating, by the processor set, an objective roadmap for the user based on the individual benchmark and the industry benchmark, the roadmap comprising first actions for improvement that are generated by measuring a first distance between a first status, the individual benchmark, and the industry benchmark.

2. The computer-implemented method of claim 1, further comprising receiving the contextualized metadata describing the user and the at least one additional individual from an external device or storage medium.

3. The computer-implemented method of claim 1, further comprising:
determining a completion of at least one of the first actions for improvement as the user performs the first actions; and
determining a second status based on the completion of at least one of the first actions.

4. The computer-implemented method of claim 3, wherein the roadmap further comprises second actions for improvement that are generated by measuring a second distance between the second status, a second individual benchmark, and the industry benchmark.

5. The computer-implemented method of claim 3, wherein at least one of the first actions for improvement and the second actions for improvement are generated using a machine learning model.

6. The computer-implemented method of claim 5, further comprising training the machine learning model using the second status, the second individual benchmark, and the industry benchmark as inputs.

7. The computer-implemented method of claim 1, wherein the metadata describing the user and at least one additional individual comprise a same context.

8. The computer-implemented method of claim 1, wherein the personal parameters describing the user comprise past interactions, communications, habits, and actions of the user.

9. The computer-implemented method of claim 1, wherein the first large language machine learning model comprises a first recurrent neural network and the second large language machine learning model comprises a second recurrent neural network.

10. A computer program product comprising one or more computer readable storage media having program instructions collectively stored on the one or more computer readable storage media, the program instructions executable to:
determine, using a first large language model, a contextualized score based on contextualized metadata describing a user and at least one additional individual;
determine, using a second large language model, a personalized score by comparing personal parameters describing the user against historical parameters;
determine an individual benchmark based on an aggregation of the contextualized score and the personalized score;
determine an industry benchmark based on historical industry benchmarks; and
generate an objective roadmap for the user based on the individual benchmark and the industry benchmark, the roadmap comprising first actions for improvement that are generated by measuring a first distance between a first status, the individual benchmark, and the industry benchmark.

11. The computer program product of claim 10, wherein the program instructions are further executable to receive the contextualized metadata describing the user and the at least one additional individual from an external device or storage medium.

12. The computer program product of claim 10, wherein the program instructions are further executable to:
determine a completion of at least one of the first actions for improvement as the user performs the first actions; and
determine a second status based on the completion of at least one of the first actions.

13. The computer program product of claim 12, wherein the roadmap further comprises second actions for improvement that are generated by measuring a second distance between the second status, a second individual benchmark, and the industry benchmark.

14. The computer program product of claim 13, wherein at least one of the first actions for improvement and the second actions for improvement are generated using a machine learning model.

15. The computer program product of claim 14, further comprising training the machine learning model using the second status, the second individual benchmark, and the industry benchmark as inputs.

16. The computer program product of claim 10, wherein the personal parameters describing the user comprise past interactions, communications, habits, and actions of the user.

17. A system comprising:
a processor set, one or more computer readable storage media, and program instructions collectively stored on the one or more computer readable storage media, the program instructions executable to:
determine, using a first large language model, a contextualized score based on contextualized metadata describing a user and at least one additional individual;
determine, using a second large language model, a personalized score by comparing personal parameters describing the user against historical parameters;
determine an individual benchmark based on an aggregation of the contextualized score and the personalized score;
determine an industry benchmark based on historical industry benchmarks; and
generate an objective roadmap for the user based on the individual benchmark and the industry benchmark, the roadmap comprising first actions for improvement that are generated by measuring a first distance between a first tracked status, the individual benchmark, and the industry benchmark.

18. The system of claim 17, wherein the program instructions are further executable to receive the contextualized metadata describing the user and the at least one additional individual from an external device or storage medium.

19. The system of claim 17, wherein the program instructions are further executable to:
determine a completion of at least one of the first actions for improvement as the user performs the first actions; and
determine a second status based on the completion of at least one of the first actions.

20. The system of claim 19, wherein the roadmap further comprises second actions for improvement that are generated by measuring a second distance between the second tracked status, a second individual benchmark, and the industry benchmark, and
wherein at least one of the first actions for improvement and the second actions for improvement are generated using a machine learning algorithm.
